(19) United States
(12) Patent Application Publication
(10) Pub. No.: US 2025/0079059 A1
(43) Pub. Date: Mar. 6, 2025

(54) COIL COMPONENT

(71) Applicants: TSUBASA MASHIO, TOKYO (JP); Motomitsu Hagiwara, TOKYO (JP); SATOSHI KANNO, TOKYO (JP); EIJI SATO, TOKYO (KP); KENTO KOSEKI, TOKYO (JP)

(72) Inventors: TSUBASA MASHIO, TOKYO (JP); Motomitsu Hagiwara, TOKYO (JP); SATOSHI KANNO, TOKYO (JP); EIJI SATO, TOKYO (KP); KENTO KOSEKI, TOKYO (JP)

(21) Appl. No.: 18/456,840

(22) Filed: Aug. 28, 2023

(51) Int. Cl. H01F 27/02; H01F 27/28; H01F 27/29

(52) U.S. Cl. CPC H01F 27/027; H01F 27/2852; H01F 27/292

(57) ABSTRACT

Disclosed herein is a coil component including a base containing resin and a plurality of magnetic metal particles, a coil conductor provided inside the base, and external electrodes provided on the base in such a manner as to be electrically connected to the coil conductor. The base includes a first section containing resin at a first content by percentage and a second section containing the resin at a second content by percentage. The first content by percentage is larger than the second content by percentage.

### CROSS REFERENCE TO RELATED APPLICATIONS

This application claims priority benefit of Japanese Patent Application No. JP 2022-138290 filed in the Japan Patent Office on Aug. 31, 2022. Each of the above-referenced applications is hereby incorporated herein by reference in its entirety.

### BACKGROUND

The technology disclosed in the present specification mainly relates to a coil component.

A coil component is installed on various electronic devices. The coil component is used for, for example, removing noise in a power line or a signal line of a circuit. The coil component includes a base, a coil conductor provided on the base, and an external electrode provided on the base. The coil component is connected to a land portion of a circuit board at the external electrode.

A metal-composite base is known as a base for the coil component. The metal-composite base includes a large number of magnetic metal particles and a binder containing a resin material. The magnetic metal particles in the base are bound by the binder. The metal-composite base can be produced by, for example, kneading the magnetic metal particles and the resin material to obtain slurry, pouring the slurry into a mold, and pressurizing the slurry in the mold. A coil component including the metal-composite base in related art is described in, for example, Japanese Patent Laid-Open No. 2020-202325.

### SUMMARY

The smaller the electronic device is, the smaller the coil component installed on the electronic device needs to be. The small coil component has a problem that the mechanical strength is lower than the mechanical strength of a relatively large coil component. The small coil component also has a problem that the magnetic characteristics (for example, inductor) are inferior to the magnetic characteristics of a relatively large coil component.

According to an embodiment of the present disclosure, it is desirable to improve the mechanical strength of a coil component. According to another embodiment of the present disclosure, it is desirable to maintain the magnetic characteristics and improve the mechanical strength in a small coil component. According to still another embodiment of the present disclosure, it is desirable to maintain the magnetic characteristics and improve the mechanical strength in a coil component including a metal-composite base.

The disclosure described in the present specification may solve other problems instead of or in addition to the problems described above. The disclosure described in the claims may solve problems other than the problems figured out from the problems described above.

A coil component according to an example of the present disclosure includes a base, a coil conductor, and external electrodes. The base contains a resin binder and a plurality of magnetic metal particles. The coil conductor is provided inside the base. The external electrodes are provided on the base in such a manner as to be electrically connected to the coil conductor. The base includes a first section containing resin at a first content by percentage and a second section containing the resin at a second content by percentage. The first content by percentage is larger than the second content by percentage.

According to the disclosure described in the present specification, a coil component excellent in mechanical strength can be obtained.

### BRIEF DESCRIPTION OF THE DRAWINGS

FIG. 1 is a perspective view of a coil component according to an example of the present disclosure;

FIG. 2 is a cross-sectional view (vertical cross-sectional view) along line I-I of the coil component of FIG. 1;

FIG. 3 is a top view of the coil component of FIG. 1;

FIG. 4 is a schematic view schematically illustrating a deflected board;

FIG. 5 is a top view illustrating a modification of the coil component illustrated in FIG. 1;

FIG. 6a is a vertical cross-sectional view illustrating a modification of the coil component illustrated in FIG. 1;

FIG. 6b is a bottom view of the coil component illustrated in FIG. 6a;

FIG. 7 is a vertical cross-sectional view illustrating a modification of the coil component illustrated in FIGS. 6a and 6b;

FIG. 8 is a flow chart illustrating a manufacturing method of the coil component according to an example of the present disclosure;

FIG. 9a is a schematic view illustrating a process of producing a first section of a base;

FIG. 9b is a schematic view illustrating a process of installing a coil conductor on the first section;

FIG. 9c is a schematic view illustrating a process of producing a second section of the base;

FIG. 9d is a schematic view illustrating a process of polishing the second section of the base; and

FIG. 9e is a schematic view illustrating a process of providing external electrodes.

### DETAILED DESCRIPTION OF THE PREFERRED EMBODIMENTS

Various embodiments of the present disclosure will now be described with reference as necessary to the drawings. The constituent elements common to a plurality of drawings are provided with the same reference signs throughout the plurality of drawings. Note that, for the convenience of description, the drawings may not be depicted in accurate scale. The embodiments of the present disclosure described below should not be construed as limiting the claimed disclosure. The elements described in the following embodiments may not be essential for the solution of the disclosure.

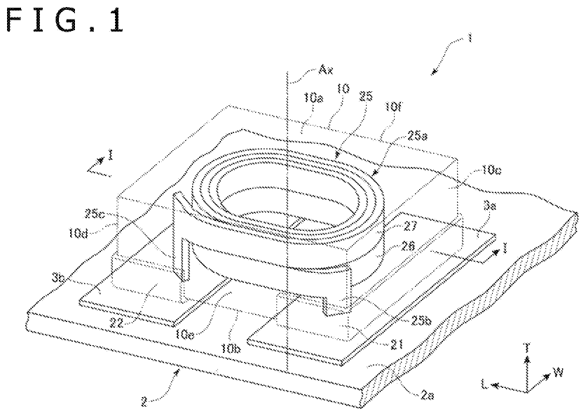

A coil component 1 according to an embodiment of the present disclosure will be described with reference to FIGS. 1 to 3. The coil component 1 is an inductor in the illustrated embodiment. The inductor may be used as a power inductor incorporated into a power line or may be used as various other inductors. The present disclosure may be applied to various coil components in addition to the illustrated inductor.

First, an outline of the coil component 1 will be described with reference mainly to FIG. 1. As illustrated in FIG. 1, the coil component 1 includes a base 10, a coil conductor 25 provided in the base 10, an external electrode 21 provided on the surface of the base 10, and an external electrode 22 provided at a position separated from the external electrode 21 on the surface of the base 10.

The coil component 1 is mounted on a mount board 2a. Land portions 3a and 3b are provided on the mount board 2a. The coil component 1 is mounted on the mount board 2a by connecting the external electrode 21 and the land portion 3a and connecting the external electrode 22 and the land portion 3b. The circuit board 2 includes the coil component 1 and the mount board 2a provided with the coil component 1. The circuit board 2 may include various electronic components in addition to the coil component 1.

The circuit board 2 may be installed on various electronic devices. Examples of the electronic devices that may be provided with the circuit board 2 include a smartphone, a tablet, a game console, a server, an electrical component of a car, and various other electronic devices. The electronic devices provided with the coil component 1 are not limited to the electronic devices illustrated in the present specification.

The base 10 is substantially cuboid. The base 10 includes a first main surface 10a, a second main surface 10b, a first end surface 10c, a second end surface 10d, a first side surface 10e, and a second side surface 10f. The outer surface of the base 10 is defined by these six surfaces. The first main surface 10a and the second main surface 10b face each other. The first end surface 10c and the second end surface 10d face each other. The first side surface 10e and the second side surface 10f face each other. The outer edges of the first main surface 10a are defined by four sides. In the illustrated embodiment, the outer edges of the first main surface 10a are defined by a pair of short sides and a pair of long sides. As in the first main surface 10a, the outer edges of the second main surface 10b are also defined by a pair of short sides and a pair of long sides. The first end surface 10c connects the short sides of the first main surface 10a and the short sides of the second main surface 10b. The first side surface 10e connects the long sides of the first main surface 10a and the long sides of the second main surface 10b.

The first main surface 10a is on the upper side of the base 10 in FIG. 1, and therefore, the first main surface 10a will be referred to as an “upper surface” in some cases. Similarly, the second main surface 10b will be referred to as a “lower surface” in some cases. The coil component 1 is arranged such that the second main surface 10b faces the mount board 2a, and therefore, the second main surface 10b will be referred to as a “mount surface” in some cases. In the present specification, a “length” direction, a “width” direction, and a “height” direction of the coil component 1 represent an “L-axis” direction, a “W-axis” direction, and a “T-axis” direction of FIG. 1, respectively, unless otherwise understood in context. The L-axis, the W-axis, and the T-axis are orthogonal to each other.

Although the surfaces 10a to 10f of the base 10 are flat surfaces in the illustrated embodiment, the surfaces 10a to 10f may be curved surfaces. Further, although the illustrated surfaces 10a to 10f are orthogonal to adjacent surfaces, the surfaces 10a to 10f may not be orthogonal to the adjacent surfaces. The vertices of the base 10 may be roundish. The ridge lines of the base 10 (lines indicating the boundaries of the adjacent surfaces among the surfaces 10a to 10f) may be curved according to the shapes and the arrangement of the surfaces 10a to 10f, instead of the straight lines.

The coil component 1 is a small coil component. The coil component 1 is formed to have, for example, a length (dimension in the L-axis direction) of 0.2 to 4.0 mm, a width (dimension in the W-axis direction) of 0.1 to 4.0 mm, and a height (dimension in the T-axis direction) of 0.1 to 4.0 mm. The length of the coil component 1 may be larger than the width. In this case, the direction along the L-axis will be referred to as a long-side direction of the coil component 1, and the direction along the W-axis direction will be referred to as a short-side direction of the coil component 1. The dimension in the short-side direction of the coil component 1 may be equal to or smaller than 3.0 mm. At least one of the length, the width, and the height of the coil component 1 may be equal to or smaller than 4.0 mm, equal to or smaller than 2.0 mm, equal to or smaller than 1.0 mm, or equal to or smaller than 0.65 mm. The coil component 1 may be thin. Specifically, the length of the coil component 1 may be larger than the height. The length of the coil component 1 may be equal to or more than twice the height and may be equal to or more than three times the height. The dimensions are illustrative only, and the coil component 1 according to the present disclosure may have any dimension within the scope of the present disclosure.

The height of the coil component 1 may be equal to or smaller than 1 mm. If the outer dimension of the coil component 1 is small, the mechanical strength becomes insufficient with respect to the stress acting on the base 10 when the coil component 1 is mounted or used, and the base 10 may be damaged when the coil component 1 is mounted or used.

The stress on the base 10 may be generated by, for example, the deflection of the mount board 2a. The mount board 2a is deflected by, for example, the thermal expansion of the mount board 2a caused by the rise in the temperature of the mount board 2a when the coil component 1 is mounted on the mount board 2a. During the use, the mount board 2a is deflected by an impact caused by vibration or drop applied to the electronic device provided with the coil component 1. During the mounting, the stress is applied from a mounter to the coil component 1.

The base 10 is easily damaged by the insufficiency in the mechanical strength of the base 10. If the base 10 is damaged, the base 10 is cracked, for example. The crack in the base 10 may cause a malfunction of an open mode or a malfunction of a short mode in the coil component 1, depending on the location of the crack. Therefore, the mechanical strength of the base 10 needs to be improved in the small coil component 1. Particularly, the base 10 is easily damaged by the deflection of the mount board 2a in the small (thin) coil component 1 with a height of 1 mm or less, and the mechanical strength of the base 10 needs to be particularly improved.

The coil conductor 25 includes a circling portion 25a extending in a circumferential direction about a coil axis Ax, a first extension portion 25b extending from one end of the circling portion 25a to the lower surface 10b of the base 10, and a second extension portion 25c extending from the other end of the circling portion 25a to the lower surface 10b of the base 10. The coil conductor 25 is provided inside the base 10. In other words, the coil conductor 25 is embedded into the base 10. The end surface of the first extension portion 25b and the end surface of the second extension portion 25c are exposed outside the base 10 from the lower surface 10b. The first extension portion 25b is connected to the external electrode 21 at the end surface exposed from the base 10, and the second extension portion 25c is connected to the external electrode 22 at the end surface exposed from the base 10.

The coil axis Ax is a virtual axis extending in a direction crossing the upper surface 10a and the lower surface 10b. The coil axis Ax may extend along the T-axis. The coil axis Ax can be, for example, an axis extending along a straight line passing through the geometric center of gravity of the upper surface 10a as viewed in the T-axis direction of the coil component 1 and similarly passing through the geometric center of gravity of the lower surface 10b as viewed in the T-axis direction of the coil component 1. In the present specification, the direction along the coil axis Ax will be referred to as an “axial direction” in some cases, and the direction orthogonal to the axial direction about the coil axis Ax will be referred to as a “radial direction” in some cases.

In the illustrated embodiment, the circling portion 25a includes a first circling portion 26 wound around for a plurality of turns about the coil axis Ax from the first extension portion 25b, and a second circling portion 27 on the positive side in the T-axis direction with respect to the first circling portion. That is, the illustrated circling portion 25a has a two-layer structure including the first circling portion 26 and the second circling portion 27 layered in the T-axis direction. One end of the first circling portion 26 is connected to the first extension portion 25b, and the other end of the first circling portion 26 is connected to one end of the second circling portion 27. The other end of the second circling portion 27 (the end on the opposite side of the end connected to the first circling portion 26) is connected to the second extension portion 25c. The first circling portion 26 and the second circling portion 27 each extend one or more turns in the circumferential direction about the coil axis Ax. The numbers of turns of the first circling portion 26 and the second circling portion 27 may be 1.5 turns or may be 2.5 turns. The numbers of turns of the first circling portion 26 and the second circling portion 27 are not limited to the numbers of turns explicitly described in the present specification. The circling portion 25a may have a single-layer structure.

The coil conductor 25 is formed in a band shape from a material excellent in conductivity, such as copper (Cu), silver (Ag), and gold (Au). The surface of the coil conductor 25 may be covered by an insulating film. The insulating film that covers the coil conductor 25 contains, for example, a thermosetting resin excellent in insulation. More specifically, the insulating film may contain a resin excellent in insulation, such as polyurethane, polyamide-imide, polyimide, polyester, and polyester-imide.

The external electrode 21 is provided on the lower surface 10b of the base 10 in such a manner as to be electrically connected to the coil conductor 25 through the first extension portion 25b, and the external electrode 22 is provided on the lower surface 10b of the base 10 in such a manner as to be electrically connected to the coil conductor 25 through the second extension portion 25c. In the illustrated embodiment, the external electrode 21 is arranged in contact with not only the lower surface 10b of the base 10, but also the first end surface 10c, the first side surface 10e, and the second side surface 10f. Similarly, the external electrode 22 is arranged in contact with not only the lower surface 10b of the base 10, but also the second end surface 10d, the first side surface 10e, and the second side surface 10f. The external electrodes 21 and 22 may be arranged in contact with only the lower surface 10b of the base 10 and not in contact with the surfaces other than the lower surface 10b of the base 10. In this way, the external electrodes 21 and 22 are arranged to cover at least part of the lower surface 10b of the base 10. In one embodiment, the external electrodes 21 and 22 are arranged not in contact with the upper surface 10a. In this way, the height of the coil component 1 can be reduced.

The external electrodes 21 and 22 include metal layers (metal foils) formed by applying a conductive paste on the surface of the base 10 by screen printing, for example, and heating the applied conductive paste. The thickness of the metal layer is, for example, 1 to 5 μm. The conductive paste contains a conductive material excellent in conductivity, such as Ag, palladium (Pd), Cu, aluminum (Al), nickel (Ni), and their alloys. The content of metal in the metal layer is, for example, 99 wt % or more. The external electrodes 21 and 22 may include plating layers formed on the metal layers. The plating layers may include two or more layers. The two or more plating layers may include an Ni plating layer and a tin (Sn) plating layer provided outside the Ni plating layer. The thickness of the plating layer is, for example, 1 to 5 μm. The thickness of the external electrodes 21 and 22 is, for example, 5 to 10 μm when the external electrodes 21 and 22 include the metal layers and the plating layers. A conductive resin layer may be provided between the metal layer and the plating layer in the external electrodes 21 and 22. The thickness of the external electrodes 21 and 22 is, for example, 10 to 20 μm when the external electrodes 21 and 22 include the metal layers, the plating layers, and the conductive resin layers.

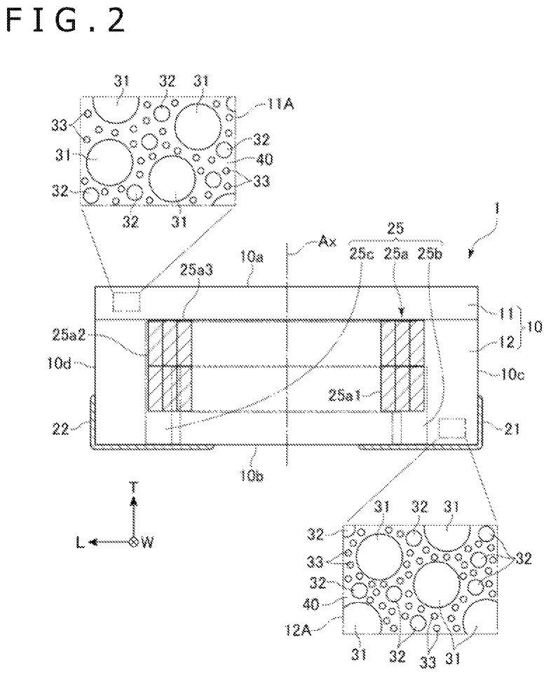

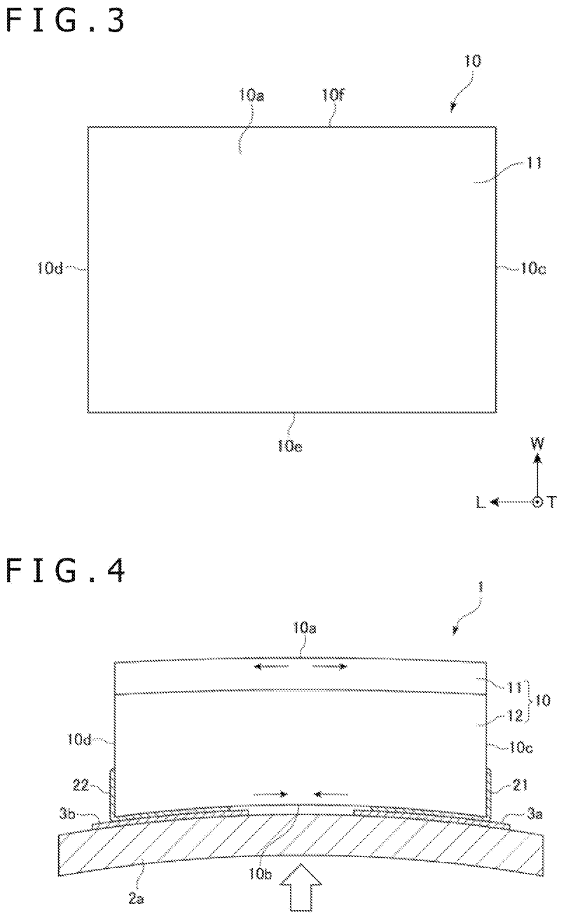

Next, a basic configuration of the base 10 will be described. A configuration for improving the mechanical strength of the base 10 will be further described with reference to FIGS. 2 and 3 after the description of the basic configuration of the base 10.

The base 10 is a metal-composite base formed from a magnetic composite material. The metal-composite base 10 is obtained by, for example, pressure-molding the slurry obtained by kneading a magnetic composite material containing magnetic metal particles and resin.

The base 10 includes a plurality of magnetic metal particles and a resin binder. The magnetic metal particles included in the base 10 may be a mixture of a plurality of types of magnetic metal particles. In the base 10, the plurality of magnetic metal particles are bound by the binder.

The magnetic metal particles included in the base 10 include, for example, (1) metal particles, such as iron (Fe) and Ni, (2) crystal alloy particles, such as an Fe-silicon (Si)-chromium (Cr) alloy, an Fe—Si—Al alloy, and an Fe—Ni alloy, (3) amorphous alloy particles, such as an Fe—Si—Cr-boron (B)—C alloy and an Fe—Si—Cr—B alloy, or (4) mixed particles with a mixture of them. The composition of the magnetic metal particles included in the base 10 is not limited to the compositions described above. For example, the magnetic metal particles included in the base 10 may include a cobalt (Co)-niobium (Nb)-Zirconium (Zr) alloy, an Fe—Zr—Cu—B alloy, an Fe—Si—B alloy, an Fe—Co—Zr—Cu—B alloy, an Ni—Si—B alloy, or an Fe—Al—Cr alloy. The magnetic metal particles included in the base 10 may contain phosphorus (P). The Fe-based magnetic metal particles included in the base 10 may contain 80 wt % or more Fe. An insulating film may be formed on the surface of each magnetic metal particle. The insulating film may be an oxide film obtained by oxidization of a metal element included in the magnetic metal particles. The insulating film provided on the surface of each magnetic metal particle may be a silicon oxide film. The silicon oxide film is coated on the surface of the magnetic metal particle by, for example, a sol-gel method.

The base 10 may include inorganic particles. The inorganic particles included in the base 10 may include silicon dioxide (SiO₂) particles (silica particles), aluminum oxide (Al₂O₃) particles, glass particles, particles containing other inorganic materials, or a mixture of them.

The binder included in the base 10 contains cured resin. The binder contains, for example, a thermosetting resin excellent in insulation. Examples of the resin material for the binder include an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, and a polybenzoxazole (PBO) resin.

The base 10 included in the coil component 1 will be described in more detail with reference to FIGS. 2 and 3. FIG. 2 is a cross-sectional view schematically illustrating a cross section of the coil component 1 along line I-I illustrated in FIG. 1, and FIG. 3 is a top view of the coil component 1. For the convenience of description, the external electrode 21 and the external electrode 22 are not illustrated in FIG. 3.

As described above, the base 10 includes a plurality of magnetic metal particles and a binder. The base 10 may also include inorganic particles. In the embodiment illustrated in FIG. 2, the base 10 includes magnetic metal particles 31, magnetic metal particles 32, and inorganic particles 33, and the magnetic metal particles are bound by a binder 40.

The average particle size of the magnetic metal particles 31 can be, for example, in a range of 10 to 60 μm, and the average particle size of the magnetic metal particles 32 can be, for example, in a range of 1 to 10 μm. The average particle size of the inorganic particles 33 can be, for example, 0.01 to 1 μm. The average particle sizes of the magnetic metal particles 31 and 32 and the inorganic particles 33 are determined as follows. The base 10 along the thickness direction (T-axis direction) is cut to expose the cross section, a scanning electron microscope (SEM) is used to photograph the cross section and acquire a SEM image, a volume-based particle size distribution is obtained on the basis of the SEM image, and the average particle sizes are determined on the basis of the obtained volume-based particle size distribution. For example, the average particle size (median diameter (D50)) calculated from the volume-based particle size distribution of the magnetic metal particles 31 obtained on the basis of the SEM image can be set as the average particle size of the magnetic metal particles 31. The particle size distribution of the particles included in the base 10 may be measured by a laser diffraction scattering method in accordance with JIS Z 8825. A laser diffraction scattering apparatus can be used to measure the particle size distribution of the particles included in the base 10. For example, a laser diffraction scattering particle size distribution measurement apparatus (model number: LA-960) manufactured by HORIBA, Ltd. in Kyoto city, Kyoto prefecture, Japan can be used to measure the particle size distribution of the particles included in the base 10.

The content of the magnetic metal particles in the base 10 may be 85 vol % or more or may be 87 vol % or more. When the base 10 includes a plurality of types of magnetic metal particles (for example, when the base 10 includes the magnetic metal particles 31 and the magnetic metal particles 32), the content of the magnetic metal particles represents the total content of the plurality of types of magnetic metal particles.

The base 10 includes a first section 11 and a second section 12. The content by percentage of the resin in the first section 11 is larger than the content by percentage of the resin in the second section 12. When the first section 11 contains the resin at a first content by percentage and the second section 12 contains the resin at a second content by percentage, the first content by percentage is larger than the second content by percentage. The resin exists as the binder 40 in the first section 11 and the second section 12. Therefore, the first content by percentage represents the content by percentage of the binder 40 in the first section 11, and the second content by percentage represents the content by percentage of the binder 40 in the second section 12. The first content by percentage can be expressed by the proportion of the area of the binder 40 to the entire area of the field of view in the SEM image of the cross section of the first section 11. The second content by percentage can be expressed by the proportion of the area of the binder 40 to the entire area of the field of view in the SEM image of the cross section of the second section 12.

FIG. 2 illustrates an enlarged view of a region 11a of part of the cross section of the first section 11 and a region 12A of part of the cross section of the second section 12. The content by percentage (first content by percentage) of the resin (binder 40) in the first section 11 is larger than the content by percentage (second content by percentage) of the resin (binder 40) in the second section 12. Therefore, the proportion of the area of the binder 40 in the region 11a of the first section 11 is larger than that of the region 12A of the second section 12, and the particles (the magnetic metal particles 31 and 32 and the inorganic particles 33) are more sparsely distributed in the region 11a.

The content by percentage of the resin in the first section 11 is larger than the content by percentage of the resin in the second section 12, and the particles are more firmly bound by the resin (binder 40) in the first section 11 than in the second section 12. The base 10 includes the first section 11 and the second section 12 in the coil component 1, and the content by percentage of the resin in the first section 11 is larger than the content by percentage of the resin in the second section 12. Therefore, the mechanical strength of the base 10 can be improved by the first section 11 in which the particles are more firmly bound than in the second section 12. The first section 11 as part of the base 10 reinforces the base 10, and the mechanical strength of the base 10 can be improved without increasing the size of the coil component 1 compared to when a reinforcement separate from the base 10 is attached to the base 10.

When the inorganic particles 33 included in the base 10 are silica particles, the silica particles enter the gaps of the magnetic metal particles 31 and 32, and the arrangement of the magnetic metal particles 31 and 32 can be stabilized. Therefore, the silica particles with a smaller diameter than that of the magnetic metal particles 31 and 32 can be included in the base 10 to further improve the mechanical strength of the base 10.

As described above, the content by percentage of the resin in the first section 11 is higher than the content by percentage of the resin in the second section 12, and the filling rate of the magnetic metal particles 31 and 32 in the first section 11 is lower than the filling rate of the magnetic metal particles 31 and 32 in the second section 12. Therefore, a second relative permeability indicating the relative permeability of the second section 12 is larger than a first relative permeability indicating the relative permeability of the first section 11.

As illustrated in FIG. 2, the coil conductor 25 is arranged in the base 10 such that an inner circumferential surface 25al and an outer circumferential surface 25a2 of the circling portion 25a are covered by the second section 12. The circling portion 25a of the coil conductor 25 includes the inner circumferential surface 25al, the outer circumferential surface 25a2, and a coil surface 25a3. The inner circumferential surface 25al of the circling portion 25a is a surface inside the circling portion 25a in the radial direction, and the outer circumferential surface 25a2 of the circling portion 25a is a surface outside the circling portion 25a in the radial direction. The coil surface 25a3 is an end surface on the upper side of the circling portion 25a in the axial direction along the coil axis Ax.

As described above, in the coil component 1, the second section 12 of the base 10 with a larger relative permeability covers the region (core region) inside the circling portion 25a in the radial direction and the region outside the circling portion 25a in the radial direction through which a large amount of magnetic flux passes. In this way, the second section 12 with a high relative permeability is arranged in the regions near the coil conductor 25 through which a large amount of magnetic flux passes, instead of the first section 11 with a low relative permeability. This can suppress the deterioration in the magnetic characteristics of the coil component 1 and improve the mechanical strength of the base 10.

The coil conductor 25 is arranged such that the coil surface 25a3 is in contact with the first section 11. In this way, the coil conductor 25 can be supported by the first section 11 with a high mechanical strength.

In the illustrated embodiment, the base 10 includes the first section 11 and the second section 12 arranged below the first section 11. The first section 11 is provided in such a manner as to cover the upper surface of the second section 12. Therefore, at least part of the upper surface 10a of the base 10 is defined by the first section 11. As illustrated in FIG. 3, the entire upper surface 10a of the base 10 is covered by the first section 11 in the illustrated embodiment. Therefore, the entire upper surface 10a of the base 10 is defined by the first section 11.

The base 10 may include a region other than the first section 11 and the second section 12. For example, the base 10 may include a third section different from the first section 11 and the second section 12, between the first section 11 and the second section 12.

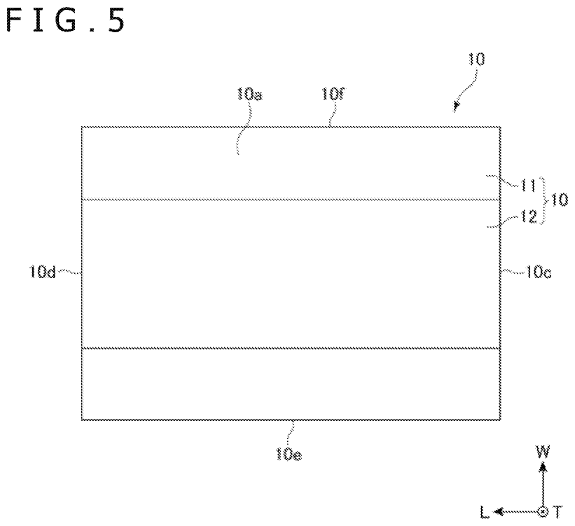

The shape and the arrangement of the first section 11 are not limited to the example illustrated in FIG. 3. For example, the first section 11 may define only part of the upper surface 10a as illustrated in FIG. 5. To effectively reinforce the mechanical strength of the base 10, it is desirable that the first section 11 extend across the entire length of the long sides of the base 10 as viewed from the upper surface of the base 10. For example, the first section 11 extends across the entire length of the long sides extending along the L-axis direction among the four sides defining the outer edges of the upper surface 10a of the base 10 in the embodiment illustrated in FIG. 5.

Next, the improvement of the mechanical strength of the base 10 owing to the first section 11 will be described with reference to FIG. 4. As described above, the coil component 1 is mounted on the mount board 2a. If the temperature of the mount board 2a rises when the coil component 1 is mounted on the mount board 2a (for example, in the reflow process), the mount board 2a may protrude to be deflected toward the coil component 1 as illustrated in FIG. 4. If the mount board 2a is deflected, the bending stress from the deflected mount board 2a acts on the coil component 1. The mount board 2a is also deflected by a drop or vibration when the coil component 1 mounted on the mount board 2a is used, and the bending stress acts on the coil component 1 due to the deflection. If the mount board 2a is deflected in the direction protruding toward the coil component 1, the tensile stress acts on the upper surface 10a of the base 10, and the compressive stress acts on the lower surface 10b. The metal-composite base 10 is generally vulnerable to the tensile stress. Therefore, if the mount board 2a is deflected, damage, such as a crack, easily occurs near the upper surface 10a in the base 10. In the illustrated embodiment, the upper surface 10a of the base 10 on which the tensile stress acts is defined by the first section 11 with a high content by percentage of the resin. This can reinforce the part on which the tensile stress acts in the base 10. In addition, the first section 11 extends across the entire length of the upper surface 10a in the long-side direction. Therefore, the first section 11 can reinforce the base 10 to prevent the tensile stress acting along the long-side direction from damaging the base 10. Further, the first section 11 can be arranged such that the entire upper surface 10a of the base 10 is defined by the first section 11, and this can more surely reinforce the base 10.

The external electrodes 21 and 22 are arranged in contact with the second section 12 of the base 10 but not in contact with the first section 11. The content by percentage of the resin in the first section 11 is higher than the content by percentage of the resin in the second section 12, and the coefficient of linear expansion of the first section 11 is different from the coefficient of linear expansion of the second section 12. Therefore, if the external electrodes 21 and 22 are in contact with both the first section 11 and the second section 12, the external electrodes 21 and 22 receive different stresses from the first section 11 and the second section 12, and the external electrodes 21 and 22 are easily peeled off from the first section 11 and the second section 12. In the coil component 1, the external electrodes 21 and 22 are arranged in contact with the second section 12 but not in contact with the first section 11. Therefore, the stress acting on the external electrodes 21 and 22 can be uniform when the first section 11 and the second section 12 expand due the rise in the temperature of the coil component 1 when the coil component 1 is used. This can prevent the external electrodes 21 and 22 from being peeled off from the base 10.

The content by percentage of the resin in the second section 12 is smaller than the content by percentage of the resin in the first section 11. On the other hand, the content by percentage of the magnetic metal particles in the second section 12 (the total content by percentage of the magnetic metal particles 31 and 32 in the illustrated example) is higher than the content by percentage of the magnetic metal particles in the first section 11. Therefore, the coefficients of linear expansion of the external electrodes 21 and 22 are closer to the coefficient of linear expansion of the second section 12 than to the coefficient of linear expansion of the first section 11. As a result, the external electrodes 21 and 22 can be attached to the second section 12 with the coefficient of linear expansion closer to the coefficients of linear expansion of the external electrodes 21 and 22, and this can prevent the external electrodes 21 and 22 from being peeled off from the base 10 when the temperature of the coil component 1 rises.

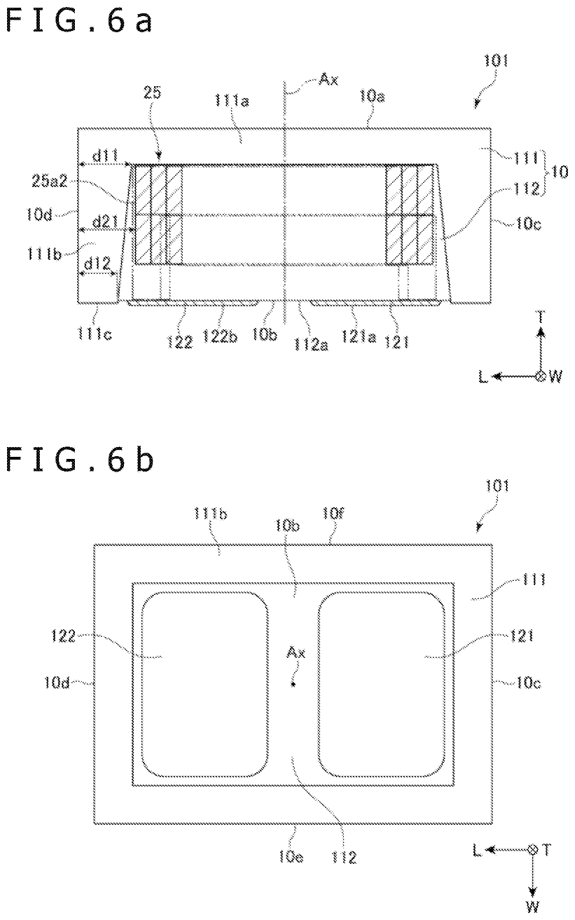

A modification of the embodiments of the present disclosure will be described with reference to FIGS. 6a and 6b. A coil component 101 illustrated in FIGS. 6a and 6b is different from the coil component 1 in that the coil component 101 includes a first section 111 in place of the first section 11, includes a second section 112 in place of the second section 12, and includes external electrodes 121 and 122 in place of the external electrodes 21 and 22.

In the coil component 101, the content by percentage of the resin in the first section 111 is larger than the content by percentage of the resin in the second section 112 as in the coil component 1. In the coil component 101, the relative permeability of the second section 112 is larger than the relative permeability of the first section 111 as in the coil component 1.

In the coil component 101, the first section 111 includes a base portion 111a that defines at least part of the upper surface 10a of the base 10 and a protrusion portion 111b that protrudes in the T-axis direction from the periphery of the base portion 111a. In the illustrated embodiment, the entire upper surface 10a of the base 10 is defined by the base portion 111a.

The protrusion portion 111b has a ring shape extending about the coil axis Ax as viewed in the T-axis direction as illustrated in FIG. 6b. The protrusion portion 111b extends from the base portion 111a to the lower surface 10b of the base 10 along the T-axis direction. Therefore, the entire first end surface 10c, second end surface 10d, first side surface 10e, and second side surface 10f are defined by the protrusion portion 111b in the illustrated embodiment.

In the base 10 including the first section 111, the entire first end surface 10c, second end surface 10d, first side surface 10e, and second side surface 10f are defined by the protrusion portion 111b with a large content by percentage of the resin. This can further improve the mechanical strength of the base 10 compared to the example in which the base 10 includes only the base portion 111a. The deflection of the mount board 2a may cause a crack extending from the lower surface 10b (particularly, near the external electrodes 121 and 122) toward the first end surface 10c, the second end surface 10d, the first side surface 10e, or the second side surface 10f in the base 10. In one example of the disclosure described in the present specification, the protrusion portion 111b with a high mechanical strength defines the surface of at least one of the first end surface 10c, the second end surface 10d, the first side surface 10e, and the second side surface 10f, and this can suppress the generation of a crack.

A width d11 of the protrusion portion 111b near the base portion 111a may be larger than a width d12 near the lower surface 10b as illustrated in FIG. 6a. In this way, the protrusion portion 111b can firmly be connected to the base portion 111a. An inner circumferential surface 111b1 of the protrusion portion 111b may be tilted with respect to the coil axis Ax. The width d11 may represent the maximum width of the protrusion portion 111b in the L-axis direction. The width d12 may represent the minimum width of the protrusion portion 111b in the L-axis direction.

The width d12 of the protrusion portion 111b near the lower surface 10b may be equal to or smaller than ½ of a distance d21 from the end surface of the base 10 (the first end surface 10c or the second end surface 10d) to the outer circumferential surface 25a2 of the circling portion 25a. In this way, the width of the second section 112 in the L-axis direction existing between the outer circumferential surface 25a2 of the circling portion 25a and the inner circumferential surface of the protrusion portion 111b can be equal to or greater than ½ of d21. The relative permeability of the second section 112 is larger than the relative permeability of the first section 111. Therefore, the magnetic flux generated by the change in the current flowing through the coil conductor 25 can easily pass through the surroundings of the circling portion 25a when the width of the second section 112 in the L-axis direction is equal to or greater than ½ of d21. This can improve the inductance of the coil component 101 compared to when the width of the protrusion portion 111b in the L-axis direction is constant at d11.

In the embodiment illustrated in FIGS. 6a and 6b, a lower surface 112a of the second section 112 is receded in the T-axis direction from a lower surface 111c of the first section 111 (that is, the lower surface 111c of the protrusion portion 111b). In other words, a region defined by the lower surface 112a of the second section 112 in the lower surface 10b of the base 10 is more recessed than a region defined by the lower surface 111c of the first section 111.

In the illustrated embodiment, both the external electrodes 121 and 122 are provided on the lower surface 112a of the second section 112. That is, the external electrodes 121 and 122 are arranged in the recessed region of the lower surface 10b of the base 10. Therefore, the dimension of the coil component 101 in the T-axis direction can be reduced by providing the external electrodes 121 and 122 on the lower surface 112a of the second section 112. Both a lower surface 121a of the external electrode 121 and a lower surface 122a of the external electrode 122 slightly protrude toward the negative side in the T-axis direction with respect to the lower surface 111c of the protrusion portion 111b. In this way, the external electrodes 121 and 122 and the land portions 3a and 3b, respectively, can surely be connected to each other.

In an embodiment different from the embodiment illustrated in FIGS. 6a and 6b, the protrusion portion 111b may extend across only a partial section around the coil axis Ax. For example, the protrusion portion 111b may define only the first end surface 10c of the base 10. The protrusion portion 111b may define only the second end surface 10d of the base 10. The protrusion portion 111b may define only the first side surface 10e of the base 10. The protrusion portion 111b may define only the second side surface 10f of the base 10. The protrusion portion 111b may define only two surfaces selected from the first end surface 10c, the second end surface 10d, the first side surface 10e, and the second side surface 10f. The protrusion portion 111b may define only three surfaces selected from the first end surface 10c, the second end surface 10d, the first side surface 10e, and the second side surface 10f. The surfaces or partial regions of the surfaces not defined by the protrusion portion 111b among the first end surface 10c, the second end surface 10d, the first side surface 10e, and the second side surface 10f are defined by the second section 112.

The first section 111 can also reinforce the mechanical strength of the base 10 in the coil component 101 as in the coil component 1. The description related to the coil component 1 also applies to the coil component 101 as much as possible.

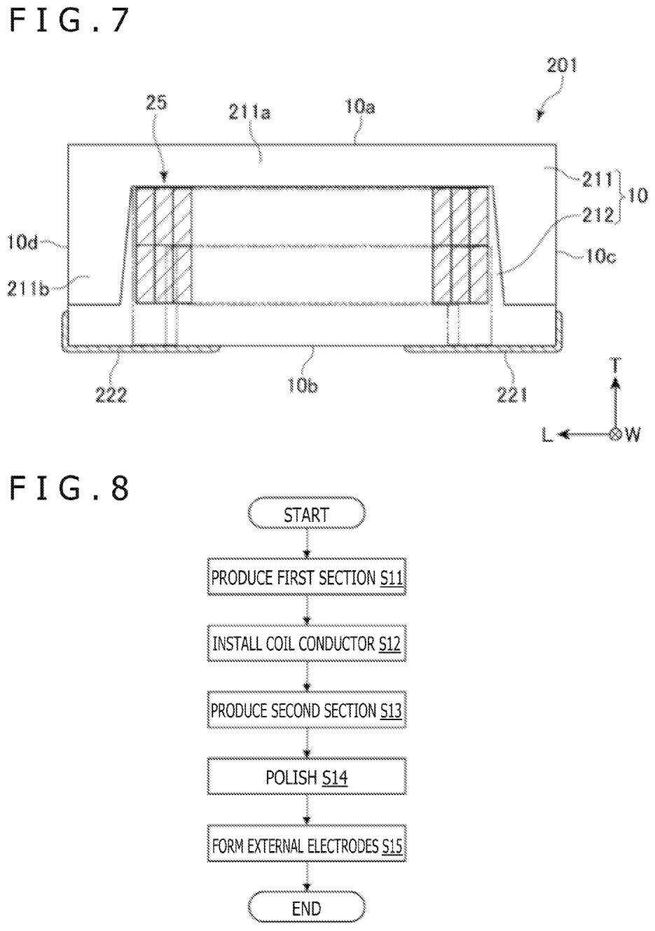

Another modification of the embodiments of the present disclosure will be described with reference to FIG. 7. A coil component 201 illustrated in FIG. 7 is different from the coil component 1 in that the coil component 201 includes a first section 211 in place of the first section 111, includes a second section 212 in place of the second section 112, and includes external electrodes 221 and 222 in place of the external electrodes 121 and 122.

In the coil component 201, the content by percentage of the resin in the first section 211 is larger than the content by percentage of the resin in the second section 212 as in the coil component 101. In the coil component 201, the second relative permeability representing the relative permeability of the second section 212 is larger than the first relative permeability representing the relative permeability of the first section 211, as in the coil component 101.

The first section 211 included in the coil component 201 includes a base portion 211a that defines at least part of the upper surface 10a of the base 10 and a protrusion portion 211b that protrudes in the T-axis direction from the periphery of the base portion 211a. In the illustrated embodiment, the entire upper surface 10a of the base 10 is defined by the base portion 211a.

Part of the second section 212 exists between the lower end of the protrusion portion 211b and the lower surface 10b of the base 10. That is, the protrusion portion 211b does not extend to the lower surface 10b of the base 10. Therefore, the lower surface 10b of the base 10 can be defined just by the second section 212, and the lower surface 10b can be flat. In this way, the external electrodes 221 and 222 can easily be installed on the lower surface 10b. The degree of freedom of the shape and arrangement of the external electrodes 221 and 222 can also be improved by making the lower surface 10b flat.

In the illustrated embodiment, the protrusion portion 211b defines part of each of the first end surface 10c, the second end surface 10d, the first side surface 10e, and the second side surface 10f. Part of the first end surface 10c is defined by the protrusion portion 211b of the first section 211, and the rest is defined by the second section 212. The area of a region of the first end surface 10c defined by the protrusion portion 211b (that is, the area of a region defined by the first section 211) is larger than the area of a region defined by the second section 212. The description related to the first section 211 and the second section 212 that define the first end surface 10c also similarly applies to the second end surface 10d, the first side surface 10e, and the second side surface 10f. That is, part of the second end surface 10d is defined by the protrusion portion 211b of the first section 211, and the rest is defined by the second section 212. Part of the first side surface 10e is defined by the protrusion portion 211b of the first section 211, and the rest is defined by the second section 212. Part of the second side surface 10f is defined by the protrusion portion 211b of the first section 211, and the rest is defined by the second section 212. The areas of the regions of the second end surface 10d, the first side surface 10e, and the second side surface 10f defined by the protrusion portion 211b are larger than the areas of the regions defined by the second section 212.

As with the external electrode 21, the external electrode 221 is arranged in contact with the lower surface 10b, the first end surface 10c, the first side surface 10e, and the second side surface 10f of the base 10. Similarly, as with the external electrode 21, the external electrode 222 is arranged in contact with the lower surface 10b, the second end surface 10d, the first side surface 10e, and the second side surface 10f of the base 10.

The external electrodes 221 and 222 are arranged in contact with the second section 212 but not in contact with the first section 211. The content by percentage of the resin in the first section 211 is higher than the content by percentage of the resin in the second section 212, and the coefficient of linear expansion of the first section 211 is different from the coefficient of linear expansion of the second section 212. Therefore, if the external electrodes 221 and 222 are in contact with both the first section 211 and the second section 212, the external electrodes 221 and 222 receive different stresses from the first section 211 and the second section 212, and the external electrodes 221 and 222 are easily peeled off from the first section 211 and the second section 212. In the coil component 201, the external electrodes 221 and 222 are arranged in contact with the second section 212 but not in contact with the first section 211. Therefore, the stress acting on the external electrodes 221 and 222 can be uniform when the first section 211 and the second section 212 expand due the rise in the temperature of the coil component 201 when the coil component 201 is used. This can prevent the external electrodes 221 and 222 from being peeled off from the base 10.

The arrangement of the external electrodes 221 and 222 can be changed from the illustrated example. For example, the external electrodes 221 and 222 may be arranged in contact with both the first section 211 and the second section 212 such that the area in contact with the second section 212 is larger than the area in contact with the first section 211. The content by percentage of the resin in the second section 212 is smaller than the content by percentage of the resin in the first section 211. On the other hand, the content by percentage of the magnetic metal particles in the second section 212 is higher than the content by percentage of the magnetic metal particles in the first section 211. Therefore, the coefficients of linear expansion of the external electrodes 221 and 222 are closer to the coefficient of linear expansion of the second section 212 than to the coefficient of linear expansion of the first section 211. As a result, by arranging the external electrode 221 such that the contact area of the external electrode 221 and the second section 212 is larger than the contact area of the external electrode 221 and the first section 211, the stress acting on the external electrode 221 from the base 10 due to the expansion of the first section 211 and the second section 212 after the rise in the temperature of the coil component 201 during the use can be smaller than when the contact area of the external electrode 221 and the first section 211 is equal to the contact area of the external electrode 221 and the second section 212 or when the contact area of the external electrode 221 and the first section 211 is larger than the contact area of the external electrode 221 and the second section 212, and this can prevent the external electrode 221 from being peeled off from the base 10. This also similarly applies to the contact area of the external electrode 222 and the first section 211 and the contact area of the external electrode 222 and the second section 212.

In the coil component 201, the first section 211 can reinforce the mechanical strength of the base 10 as in the coil components 1 and 101. The description related to the coil components 1 and 101 also applies to the coil component 201 as much as possible.

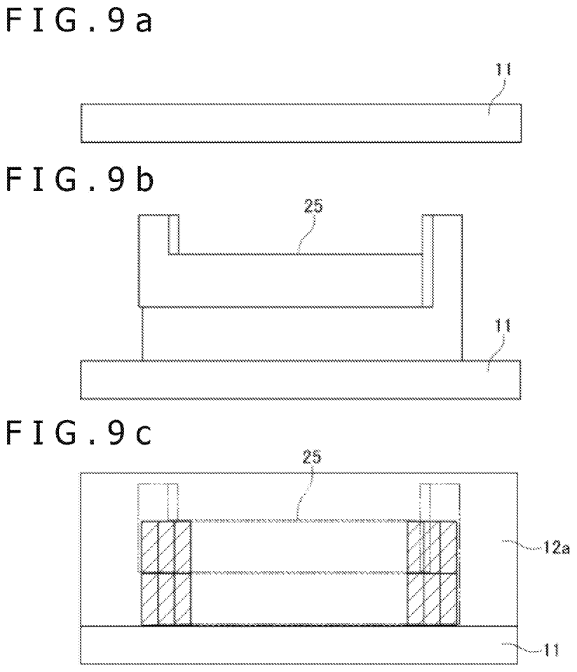

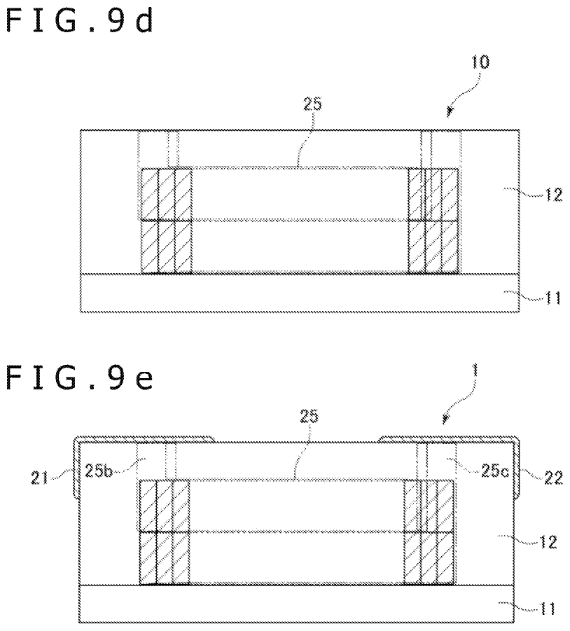

Next, a manufacturing method of the coil component 1 according to one embodiment of the present disclosure will be described with reference to FIGS. 8 and 9a to 9e.

In step S11, the first section 11 of the base 10 is produced. The first section 11 is produced by, for example, a compression molding method. To produce the first section 11 by the compression molding method, a first magnetic composite material is compressed and molded. More specifically, slurry of the first magnetic composite material obtained by kneading a plurality of magnetic metal particles and resin is poured into a first mold, and a molding pressure is applied to the slurry in the mold at a temperature equal to or greater than the thermosetting temperature of the resin to produce the first section 11 as illustrated in FIG. 9a. The magnetic metal particles included in the first magnetic composite material are, for example, mixed particles of the magnetic metal particles 31 and the magnetic metal particles 32. The first magnetic composite material may contain the inorganic particles 33. The resin included in the first magnetic composite material is the thermosetting resin which is, for example, an epoxy resin.

In step S12, the coil conductor 25 prepared in advance is installed on the first section 11 as illustrated in FIG. 9b. The coil conductor 25 is produced with use of, for example, a well-known winding machine, such as a spindle winding machine, to wind a metal band around a core bar.

In step S13, the first section 11 provided with the coil conductor 25 is installed in a second mold. A second magnetic composite material is poured into the second mold, and a molding pressure is applied to the second mold to produce a structure including the first section 11 and a molded body 12a provided with the coil conductor 25 inside. The second magnetic composite material contains magnetic metal particles and resin. The magnetic metal particles included in the second magnetic composite material are, for example, mixed particles of the magnetic metal particles 31 and the magnetic metal particles 32. The second magnetic composite material may contain the inorganic particles 33. The resin included in the second magnetic composite material is the thermosetting resin which is, for example, an epoxy resin. The content by percentage of the resin in the second magnetic composite material is smaller than the content by percentage of the resin in the first magnetic composite material.

In step S14, the upper surface of the molded body 12a is polished. The upper surface of the molded body 12a is polished to expose the first extension portion 25b and the second extension portion 25c of the coil conductor 25. The molded body 12a is formed into the second section 12 through the polishing process. The base 10 that includes the first section 11 and the second section 12 and is provided with the coil conductor 25 inside is obtained in step S14.

In step S15, a conductive paste is applied to the surface of the base 10 to form the external electrode 21 and the external electrode 22. The external electrode 21 is provided on the surface of the base 10 in such a manner as to be electrically connected to the first extension portion 25b of the coil conductor 25. The external electrode 22 is provided on the surface of the base 10 in such a manner as to be electrically connected to the end portion of the second extension portion 25c of the coil conductor 25. As described above, the external electrodes 21 and 22 may include Ni plating layers, Sn plating layers, and conductive resin layers.

The coil component 1 is manufactured in this way. The manufacturing method of the coil component 1 is not limited to the method described above. At least one of the first section 11 and the second section 12 may be produced by a transfer molding method or a sheet lamination method instead of the compression molding method.

In the above manufacturing method, the first section 11 is produced from the first magnetic composite material with the content by percentage of the resin larger than that of the second magnetic composite material. Therefore, the content by percentage of the resin in the first section 11 is larger than the content by percentage of the resin in the second section 12. In this way, the above manufacturing method is used to manufacture the coil component 1 in which the mechanical strength of the base 10 is improved by the first section 11.

The content by percentage of the resin of the first magnetic composite material and the content by percentage of the resin of the second magnetic composite material are different, and the curing shrinkage rate of the first magnetic composite material and the curing shrinkage rate of the second magnetic composite material are different. Therefore, if the first magnetic composite material and the second magnetic composite material are cured at the same time, the residual stress tends to be large in the molded body obtained after curing, due to the difference in the shrinkage rate. According to the manufacturing method described above, the first magnetic composite material is cured to produce the first section 11 in step S11, and then the second magnetic composite material is cured to produce the second section 12 in step S13. This can prevent the generation of the residual stress caused by the difference between the shrinkage rate of the first magnetic composite material and the shrinkage rate of the second magnetic composite material.

The coil components 101 and 201 can also be manufactured by a method similar to the method for the coil component 1.

The dimension, the material, and the arrangement of each constituent element described in the present specification are not limited to those explicitly described in the embodiments, and each constituent element can be modified to have any dimension, material, and arrangement within the scope of the present disclosure. In addition, constituent elements not explicitly described in the present specification may also be added to the described embodiments, and some of the constituent elements described in the embodiments may also be removed.

Part of the processes included in the manufacturing method described in the present specification can appropriately be removed as long as there is no contradiction. A process not explicitly described in the present specification may be executed as necessary in the manufacturing method described in the present specification. The order of part of the processes included in the manufacturing method described in the present specification may appropriately be switched and executed without departing from the scope of the present disclosure. Part of the processes included in the manufacturing method described in the present specification may be executed at the same time or in parallel if possible.

The terms such as “first,” “second,” “third,” and so on in the present specification are provided to identify the constituent elements, and the terms do not necessarily limit the numbers, the orders, and the details of the constituent elements. In addition, the numbers for identifying the constituent elements are used on the basis of context, and the numbers used in one context may not represent the same components in another context. Further, the constituent elements identified by numbers may also have functions of the constituent elements identified by other numbers.

The following technique is also disclosed in the present specification.

### [Supplement 1]

A coil component including:
a base containing a resin and a plurality of magnetic metal particles;
a coil conductor provided inside the base; and
external electrodes provided on the base in such a manner as to be electrically connected to the coil conductor, in which
the base includes a first section containing resin at a first content by percentage and a second section containing the resin at a second content by percentage, and
the first content by percentage is larger than the second content by percentage.

### [Supplement 2]

The coil component according to supplement 1, in which
the base includes a first surface and a second surface facing the first surface and a board,
the external electrodes are arranged to cover at least part of the second surface, and
at least part of the first surface of the base is defined by the first section.

### [Supplement 3]

The coil component according to supplement 1 or 2, in which
the first surface includes a first long side and a first short side, and
the first section extends across an entire length of the first long side on the first surface.

### [Supplement 4]

The coil component according to any one of supplements 1 to 3, in which
an entirety of the first surface of the base is defined by the first section.

### [Supplement 5]

The coil component according to any one of supplements 1 to 4, in which
the second surface includes a second long side and a second short side,
the base includes a third surface (10c) connecting the first short side of the first surface and the second short side of the second surface, and
at least part of the third surface is defined by the first section.

### [Supplement 6]

The coil component according to any one of supplements 1 to 5, in which
the base includes a fourth surface facing the third surface, and
at least part of the fourth surface is defined by the first section.

### [Supplement 7]

The coil component according to any one of supplements 1 to 6, in which
the base includes a fifth surface connecting the first long side of the first surface and the second long side of the second surface, and
at least part of the fifth surface is defined by the first section.

### [Supplement 8]

The coil component according to any one of supplements 1 to 7, in which
the base includes a sixth surface facing the fifth surface, and
at least part of the sixth surface is defined by the first section.

### [Supplement 9]

The coil component according to any one of supplements 1 to 8, in which
the third surface is defined by the first section and the second section, and
a first area representing an area of a region of the third surface defined by the first section is larger than a second area representing an area of a region of the third surface defined by the second section.

### [Supplement 10]

The coil component according to any one of supplements 1 to 9, in which
the coil conductor includes a circling portion extending in a circumferential direction about a coil axis,
an inner circumferential surface and an outer circumferential surface of the circling portion are covered by the second section,
the first section has a first relative permeability,
the second section has a second relative permeability, and
the second relative permeability is larger than the first relative permeability.

### [Supplement 11]

The coil component according to any one of supplements 1 to 10, in which
the circling portion includes a coil surface facing the first surface of the base, and is arranged in contact with the first section at the coil surface.

### [Supplement 12]

The coil component according to any one of supplements 1 to 11, in which
the coil conductor includes extension portions (25b and 25c) extending from one end of the circling portion to the second surface of the base.

### [Supplement 13]

A coil component including:
a base containing resin and a plurality of magnetic metal particles;
a coil conductor provided inside the base; and
external electrodes provided on the base in such a manner as to be electrically connected to the coil conductor, in which
the base includes a first section containing resin at a first content by percentage and a second section containing the resin at a second content by percentage, and
the first content by percentage is larger than the second content by percentage, where a content by percentage represents proportion of an area of the resin to an entire area in observation of cross section in one field of view.

### [Supplement 14]

A circuit board including the coil component according to any one of supplements 1 to 13.

### [Supplement 15]

An electronic component including the circuit board according to supplement 14.

### [Supplement 16]

A manufacturing method of a coil component, the manufacturing method including:
a process of producing a first section containing resin at a first content by percentage, from a first magnetic composite material;
a process of installing a coil conductor on the first section;
a process of producing a second section containing the resin at a second content by percentage, from a second magnetic composite material in such a manner as to cover the coil conductor; and
a process of providing external electrodes on the second section, in which
the first content by percentage is larger than the second content by percentage.

What is claimed is:

1. A coil component comprising:
a base containing resin and a plurality of magnetic metal particles;
a coil conductor provided inside the base; and
external electrodes provided on the base in such a manner as to be electrically connected to the coil conductor, wherein
the base includes a first section containing resin at a first content by percentage and a second section containing the resin at a second content by percentage, and
the first content by percentage is larger than the second content by percentage.

2. The coil component according to claim 1, wherein
the base includes a first surface and a second surface facing the first surface and a board,
the external electrodes are arranged to cover at least part of the second surface, and
at least part of the first surface of the base is defined by the first section.

3. The coil component according to claim 2, wherein
the first surface includes a first long side and a first short side, and
the first section extends across an entire length of the first long side on the first surface.

4. The coil component according to claim 1, wherein
an entirety of the first surface of the base is defined by the first section.

5. The coil component according to claim 3, wherein
the second surface includes a second long side and a second short side,
the base includes a third surface connecting the first short side of the first surface and the second short side of the second surface, and
at least part of the third surface is defined by the first section.

6. The coil component according to claim 5, wherein
the base includes a fourth surface facing the third surface, and
at least part of the fourth surface is defined by the first section.

7. The coil component according to claim 5, wherein
the base includes a fifth surface connecting the first long side of the first surface and the second long side of the second surface, and
at least part of the fifth surface is defined by the first section.

8. The coil component according to claim 7, wherein
the base includes a sixth surface facing the fifth surface, and
at least part of the sixth surface is defined by the first section.

9. The coil component according to claim 5, wherein
the third surface is defined by the first section and the second section, and
a first area representing an area of a region of the third surface defined by the first section is larger than a second area representing an area of a region of the third surface defined by the second section.

10. The coil component according to claim 1, wherein
the coil conductor includes a circling portion extending in a circumferential direction about a coil axis,
an inner circumferential surface and an outer circumferential surface of the circling portion are covered by the second section,
the first section has a first relative permeability,
the second section has a second relative permeability, and
the second relative permeability is larger than the first relative permeability.

11. The coil component according to claim 10, wherein
the circling portion includes a coil surface facing the first surface of the base, and is arranged in contact with the first section at the coil surface.

12. The coil component according to claim 10, wherein
the coil conductor includes extension portions extending from one end of the circling portion to the second surface of the base.

13. A coil component comprising:
a base containing resin and a plurality of magnetic metal particles;
a coil conductor provided inside the base; and
external electrodes provided on the base in such a manner as to be electrically connected to the coil conductor, wherein
the base includes a first section containing resin at a first content by percentage and a second section containing the resin at a second content by percentage, and
the first content by percentage is larger than the second content by percentage, where a content by percentage represents proportion of an area of the resin to an entire area in observation of cross section in one field of view.
